(19) United States
(12) Patent Application Publication
(10) Pub. No.: US 2023/0286045 A1
(43) Pub. Date: Sep. 14, 2023

(54) METHODS OF FORMING ARTICLES BY APPLYING ELECTRIC CURRENT AND PRESSURE TO MATERIALS, AND RELATED ARTICLES

(71) Applicant: Battelle Energy Alliance, LLC, Idaho Falls, ID (US)

(72) Inventors: Ryann E. Bass, Ammon, ID (US); Jorgen Rufner, Idaho Falls, ID (US); Michael D. McMurtrey, Idaho Falls, ID (US); Xinchang Zhang, Idaho Falls, ID (US); Troy B. Holland, New Albany, IN (US)

(21) Appl. No.: 18/183,513

(22) Filed: Mar. 14, 2023

Related U.S. Application Data
(60) Provisional application No. 63/269,302, filed on Mar. 14, 2022.

(51) Int. Cl. B22F 7/04; B21D 53/04

(52) U.S. Cl. CPC B22F 7/04; B21D 53/04

(57) ABSTRACT

A method of forming an article comprises placing a first material and a second material in a die of a direct current sintering apparatus. The second material directly contacts the first material. An electric current and pressure are applied to the first material and the second material to form an article. An additional method comprises placing a nickel-based material in direct contact with one or more other nickel-based materials to form a stack of nickel-based materials. An electric current and pressure are applied to the stack of nickel-based materials to join the nickel-based material and the one or more other nickel-based materials. Related articles are also disclosed.

### CROSS-REFERENCE TO RELATED APPLICATION

This application claims the benefit under 35 U.S.C. § 119(e) of U.S. Provisional Patent Application Ser. No. 63/269,302, filed Mar. 14, 2022, the disclosure of which is hereby incorporated herein in its entirety by this reference.

### STATEMENT REGARDING FEDERALLY SPONSORED RESEARCH OR DEVELOPMENT

This invention was made with government support under Contract Number DE-AC07-05-ID14517 awarded by the United States Department of Energy. The government has certain rights in the invention.

### TECHNICAL FIELD

Embodiments of the disclosure relate generally to a material joining process for the fabrication of compact heat exchangers. More particularly, embodiments of the disclosure relate to methods of joining (e.g., diffusion welding, diffusion bonding) materials to form an article and to articles including the article.

### BACKGROUND

Many of today's high-performance technologies (e.g., nuclear reactors, spacecraft, concentrated solar plants and hydrogen cells) require advanced materials. The advanced materials are made of metals and/or ceramics that can withstand extreme (e.g., temperature, environmental) conditions or meet exacting specifications. Compact heat exchangers for nuclear applications use advanced materials to withstand the extreme environment in which they operate.

Diffusion welding is a technique to join advanced materials for the fabrication of compact heat exchangers. Diffusion welding is a solid-state joining technique where atomic diffusion across contacting surfaces forms a bond between components. This is induced by high temperatures and pressures. Diffusion welding is conventionally achieved by hot pressing sheets of material where heat and pressure are simultaneously applied for long periods of time to join mating surfaces of the materials. INCONEL® 617 is a metal alloy that has been investigated for use as an advanced material because of its material properties. The desirable material properties of INCONEL® 617 result in it being a preeminent candidate for the fabrication of compact heat exchangers for nuclear applications. There have been multiple endeavors to diffusion weld INCONEL® 617. Although fully bonded interfaces in conventional diffusion welded INCONEL® 617 have been achieved, grain boundary migration across the bonding interface is hindered by extensive precipitation at the bonding interface. Bonds of this nature have been observed to have degraded elevated-temperature mechanical properties compared to the wrought product form of INCONEL® 617.

As is known in the art, diffusion welding is not limited to joining materials that are nickel based. Diffusion welding is capable of joining similar and dissimilar metals, such as titanium alloy/stainless steel, nickel alloy 800H, nickel alloy GH4099, Ti/Al, and stainless steel/copper. For fabricating compact heat exchangers, a number of sheets with defined cooling recesses are bonded via diffusion welding. Optimized diffusion welding parameters can produce a microstructure that has metallurgical continuity and achieve similar properties as the material in the wrought-product form.

Many endeavors in diffusion welding of INCONEL® 617 have used hot pressing; these are well known in the art. The microstructure and high-temperature mechanical properties of INCONEL® 617, which was hot-pressed at 1150° C. for 2 hours under a uniaxial pressure of 14.7 MPa, have been studied. The results showed very limited grain boundary migration across the interface. This poor GB migration was often reported in diffusion welding of INCONEL® 617 using hot pressing with different temperature, hold time, and pressure. Such unsatisfactory GB migration was often attributed to the extensive chromium-rich carbides and aluminum-rich oxides along the interface, which inhibited atomic diffusion over the interface. Microstructural discontinuities at the interface of the two materials are detrimental to the mechanical properties of the joined material. This is evidenced by the noticeable reduction of rupture strength of the diffusion weld compared to that of the base metal. Due to the extensive precipitates and limited GB migration, hot-pressed INCONEL® 617 was found to have significantly reduced creep performance with rupture at the interface. A 2.5 μm thick pure nickel interlayer has been used in the prior art to bond INCONEL® 617 plates. Nevertheless, microstructural discontinuities were still seen at the interface with no noticeable grain boundary migration. In the prior art, the nickel interlayer also caused secondary phase particles and pores at the interface, which weakened the bonding strength of the weld. Post-weld heat treatment at a certain temperature may achieve some grain boundary migration, but this process has limitations such as inefficiency, geometric distortion, and oxidation for large diffusion-welded stacks. The embodiments of the disclosure seek to remedy the above deficiencies of diffusion welding.

### BRIEF SUMMARY

A method of forming an article is disclosed and comprises placing a first material and a second material in a die of a direct current sintering apparatus. The second material directly contacts the first material. An electric current and pressure are applied to the first material and the second material to form an article.

An additional method of forming an article is disclosed and comprises placing a nickel-based material in direct contact with one or more other nickel-based materials to form a stack of nickel-based materials. An electric current and pressure are applied to the stack of nickel-based materials to join the nickel-based material and the one or more other nickel-based materials.

An article is also disclosed and comprises a first material comprising a first nickel alloy. A second material comprises a second nickel alloy and is diffusion bonded to the first material. An interface between the first material and the second material is substantially free of voids and cracks.

### BRIEF DESCRIPTION OF THE DRAWINGS

FIG. 1. is a flow diagram of a material joining process, in accordance with embodiments of the disclosure;

FIG. 2 is a schematic of an apparatus for forming an article, in accordance with embodiments of the disclosure;

FIG. 3A-FIG. 3C show a process of joining two materials in accordance with embodiments of the disclosure;

FIG. 4 shows an apparatus used to manufacture the article, in accordance with embodiments of the disclosure;

FIG. 5 is a schematic of a plate fin compact heat exchanger comprising the article in accordance with embodiments of the disclosure;

FIG. 6 shows an enlarged view of the fins in the plate fin compact heat exchanger of FIG. 9;

FIG. 7 is a simplified schematic of a compact heat exchanger in accordance with embodiments of the disclosure;

FIG. 8 shows an enlarged view of recesses of the compact heat exchanger of FIG. 11;

FIG. 9 is a graph showing processing parameters used in the material joining process, in accordance with embodiments of the disclosure;

FIG. 10 is a graph showing a heating differential of the material joining process, in accordance with embodiments of the disclosure;

FIG. 11 is a schematic of the heating differential measuring method, in accordance with embodiments of the disclosure; and

FIG. 12A-FIG. 12C are photomicrographs of articles formed by the material joining process, in accordance with embodiments of the disclosure.

### DETAILED DESCRIPTION

Illustrations presented herein are not meant to be actual views of any particular material, component, or system, but are merely idealized representations that are employed to describe embodiments of the disclosure.

The following description provides specific details, such as material types, dimensions, and processing conditions in order to provide a thorough description of embodiments of the disclosure. However, a person of ordinary skill in the art will understand that the embodiments of the disclosure may be practiced without employing these specific details. Indeed, the embodiments of the disclosure may be practiced in conjunction with conventional fabrication techniques employed in the industry. In addition, the description provided below does not form a complete process flow, system, or method for forming an article for the fabrication of a compact heat exchanger for nuclear applications. Only those process acts and structures necessary to understand the embodiments of the disclosure are described in detail below. Additional acts to form a compact heat exchanger may be performed by conventional techniques. Further, any drawings accompanying the present application are for illustrative purposes only and, thus, are not drawn to scale. Additionally, elements common between figures may retain the same numerical designation.

According to embodiments described herein, a material joining process for forming an article may be utilized to fabricate the article configured to withstand extreme conditions or meet exacting specifications, such as compact heat exchangers, or similar devices. The material joining process includes a diffusion welding (e.g., diffusion bonding) process. Diffusion welding may be accomplished by a technique, such as, spark plasma sintering (SPS) or electric-field-assisted sintering (EFAS). Specifically, the material joining process includes passing a high current density (e.g., electric current) between adjacent materials and applying pressure to form the article. The article may exhibit equivalent or improved material properties, such as creep, elevated-temperature fatigue, and creep-fatigue, to material properties of the base material (e.g., base-metal, wrought product form).

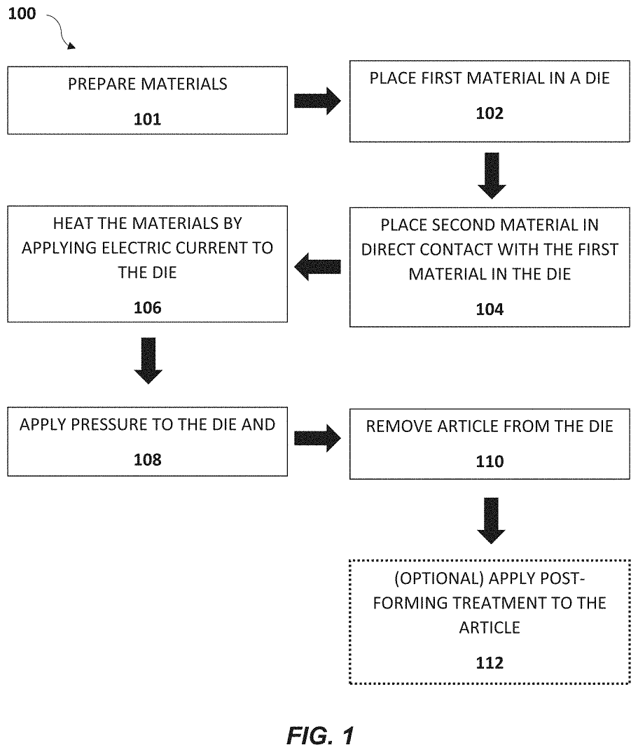

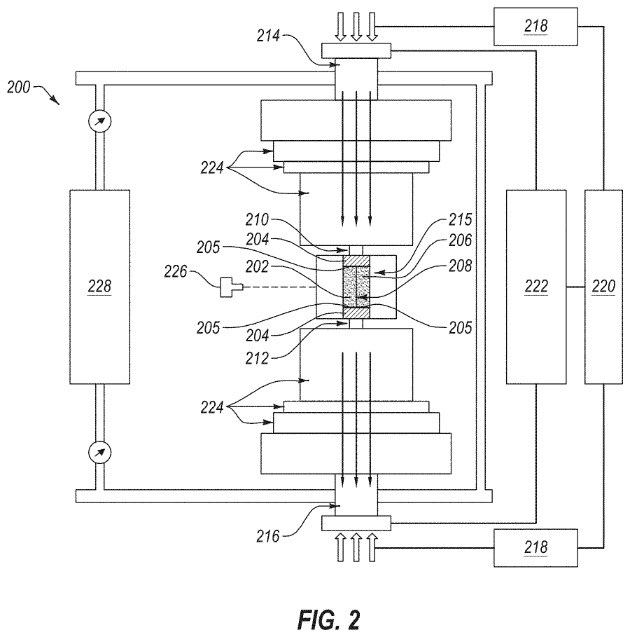

FIG. 1 shows a process 100 for forming an article from two or more materials, in accordance with embodiments of the disclosure. FIG. 2 shows a schematic of an apparatus 200 for the material joining process 100 described in FIG. 1. The two or more materials are electrically conductive materials. As used herein, the term “material” means and includes a chemical composition including one or more of chemical compounds, where the material is configured in a three-dimensional form. The material may be configured as a sheet, a layer, a plate, or other configuration. The article may be used to fabricate a compact heat exchanger, or similar device, for energy applications, such as advanced nuclear reactors, concentrated solar power, or fossil fuel applications. An article 215 includes a first material 202 and a second material 206, which are joined together following the application of an electrical current and pressure. By applying the electrical current and pressure, one or more of the temperature, pressure, and electrical current may be adjusting during the material joining process. The first material 202 and the second material 206 may comprise substantially the same material composition (e.g., chemical composition), or may comprise different material compositions (e.g., chemical compositions). While the first material 202 and the second material 206 are described as sheets of material, other configurations, such as plates, are contemplated. The article 215 may be formed by joining from 2 sheets of material to 100 sheets of material, such as from 10 sheets of material to 90 sheets of material, from 20 sheets of material to 80 sheets of material, or from 35 sheets of material to 65 sheets of material. While the joining process described and illustrated herein includes joining the first material 202 and the second material 206, the material joining process in accordance with embodiments of the disclosure may be used to join a greater number of materials, such as up to 100 materials.

Each sheet of material may exhibit a length of from about 14.14 mm to about 283 mm, and a width of from about 14.14 mm to about 283 mm. For example, the length of the material may be from about 20 mm to about 220 mm in length, such as from about 50 mm to about 200 mm in length, from about 80 mm to about 150 mm in length, or from about 100 mm to about 200 mm in length. The width of the material may be from about 20 mm to about 220 mm, such as from about 50 mm to about 200 mm in width, from about 80 mm to about 150 mm in width, or from about 100 mm to about 200 mm in width. The sheet of material may exhibit a thickness of from about 1.25 mm to about 1.70 mm. However, a greater material thickness may be used if the electric current is increased. Furthermore, if the sheet of material exhibits a round shape, each sheet may comprise a diameter of from about 20 mm to about 220 mm, such as a diameter of 283 mm and a thickness of 1.35 mm.

With combined reference to FIGS. 1 and 2, process 100 includes placing 102 a first material 202 in a die 204 of the apparatus 200. The die 204 may be formed of graphite or other appropriate material. The apparatus also includes a system controller 220 and a current controller 222 operably coupled to the die 204. The apparatus 200 may also include a cooling system 228 operably coupled to the die 204. The first material 202 may comprise a metal alloy, such as an alloy of nickel or titanium and one or more of manganese, stainless steel, chromium, cobalt, molybdenum, aluminum, carbon, iron, silicon, sulfur, copper, boron, tungsten, and phosphorus. The first material 202 may, for example, include nickel, chromium, cobalt, molybdenum, aluminum, carbon, iron, manganese, silicon, sulfur, titanium, copper, boron, and phosphorus. Alternatively, the first material 202 may include nickel, chromium, cobalt, molybdenum, iron, aluminum, and titanium. The first material 202 may comprise an alloy of nickel and chromium (e.g., an alloy including nickel, chromium, and one or more of molybdenum, tungsten, and cobalt, such as INCONEL® 617, INCONEL® 718, alloy 600, and alloy X-750). A second material 206 is placed 104 in the die 204 and is placed adjacent to (e.g., in direct contact with) a contact surface 208 of the first material 202. The second material 206 may also comprise a metal alloy, such as an alloy of nickel or titanium and one or more of manganese, stainless steel, chromium, cobalt, molybdenum, aluminum, carbon, iron, silicon, sulfur, copper, boron, tungsten, and phosphorus. The second material 206 may comprise an alloy of nickel and chromium (e.g., alloys including nickel, chromium, and one or more of molybdenum, tungsten, and cobalt, such as INCONEL® 617, INCONEL® 718, alloy 600, alloy X-750). The first material 202 may be an alloy of nickel and chromium that comprises from about 44.5 weight percent (wt %) to about 53 wt % nickel, from about 20 wt % to about 24 wt % chromium, from about 10 wt % to about 15 wt % cobalt, from about 8 wt % to about 10 wt % molybdenum, and from about 0.05 wt % to about 0.15 wt % carbon. The first material 202 and the second material 206 may comprise the same metal alloy, such as an alloy of nickel, titanium, or different metal alloys. Furthermore, the second material 206 may be comprised of from about 44.5 wt % to about 53 wt % nickel, from about 20 wt % to 24 wt % chromium, from about 10 wt % to about 15 wt % cobalt, from about 8 wt % to about 10 wt % molybdenum, and from about 0.05 wt % to about 0.15 wt % carbon. In some embodiments, each of the first material 202 and the second material 206 comprise INCONEL® 617.

The material compositions of the first 202 and second 206 materials may be selected based on a difference in melting points between the two materials. For example, the melting point of the first material may be substantially the same as the second material, with the material compositions of the first 202 and second 206 materials being different than one another. Alternatively, the first material and the second material may have a difference in melting point of less than about 50° C., such as less than about 40° C., less than about 30° C., or less than about 20° C. By way of example only, the melting point of the first material 202 may be in the range of about 1300° C. to about 1400° C., such as from about 1320° C. to about 1390° C., or from about 1330° C. to about 1380° C. and the melting point of the second material 206 may be in the range of from about 1300° C. to about 1400° C., such as from about 1320° C. to about 1390° C., or from about 1330° C. to about 1380° C. To modify the thermoelectric properties of the materials 202 and 206, an additional barrier 205 may be placed between the first 202 material and the die 204. An additional barrier 205 may be placed between the second material 206 and the die 204. The barrier 205 may be a carbon-carbon composite plate or a tantalum foil.

The process 100 shown in FIG. 1 continues with applying 106 electric current (e.g., current density) to the die 204, such as to an upper punch 210 and a lower punch 212 of the die 204, during the material joining process. The apparatus 200 of FIG. 2 shows the second material 206 adjacent to (e.g., in direct contact with) the contact surface 208 of the first material 202 in the die 204. The first and second materials 202, 206 are positioned in the die 204 between spacers 224 of the apparatus 200. The application of the electric current heats the first material 202 and the second material 206. Unlike hot pressing where materials are heated externally, the material joining process in accordance with embodiments of the disclosure uses the electric current to heat the materials by so-called “Joule Heating.” The magnitude of electric current which flows through the upper punch 210 and the lower punch 212 and consequently, the materials, depends on the desired temperature to which the materials (e.g., first material 202 and second material 206) are to be heated. The magnitude of electric current also depends on the materials' 202, 206 properties, the die geometry, the geometry of the upper punch 210, the geometry of the lower punch 212, and the size of the materials 202, 206. The upper punch 210 and the lower punch 212 may be substantially the same size as one another. While the upper punch 210 and the lower punch 212 are illustrated in FIG. 2 as being relatively smaller than the sheets of material of the article 215, length and width dimensions of the upper punch 210 and the lower punch 212 may be substantially the same as length and width dimensions of the sheets of material in the article 215 to provide substantially uniform heating of the first material 202 and the second material 206. The apparatus 200 may include an upper electrode 214 and a lower electrode 216 for conducting the electric current to the upper punch 210 and lower punch 212. The electric current applied to the upper and lower electrodes 214, 216 may be initiated by the current controller 222. Since the first material 202 and the second material 206 are electrically conductive materials, the electric current applied to the punch 210, 212 passes through the materials.

The electric current applied to the punch (e.g., upper punch 210, lower punch 212) may range from about 1240 amps (A) to about 50,000 A, such as from about 1240 A to about 48,000 A, from about 1300 A to about 46,000 A, from about 1325 A to about 42,000 A, from about 10,000 A to about 50,000 A, from about 20,000 A to about 50,000 A, from about 30,000 A to about 50,000 A, from about 40,000 A to about 50,000 A, or from about 45,000 A to about 50,000 A. The electrical current may be selected depending on the dimensions and other properties of the first and second materials 202, 206. The magnitude of electric current applied corresponds to a fabrication temperature during the material joining process. The fabrication temperature may include one or more of a temperature of a punch material, a temperature of a die material, a temperature of the first material 202, a temperature of the second material 206, or a temperature of the barrier 205. The fabrication temperature generated by the applied electric current may depend on the resistivity and the thickness of the material of the punch, the geometry of the punch (e.g., upper punch 210, lower punch 212), the geometry of the die 204, the material of the die 204, and the material compositions of the first 202 and second 206 materials. For example, a stack of 3 sheets of material, all having the same composition and through which an electric current of 1240 A, 1322 A and 1377 A are applied may generate a fabrication temperature of 1050° C., 1100° C., and 1150° C., respectively. Specifically, an electric current 1377A may generate a fabrication temperature of 1150° C. using a punch defined by a cylindrical shape.

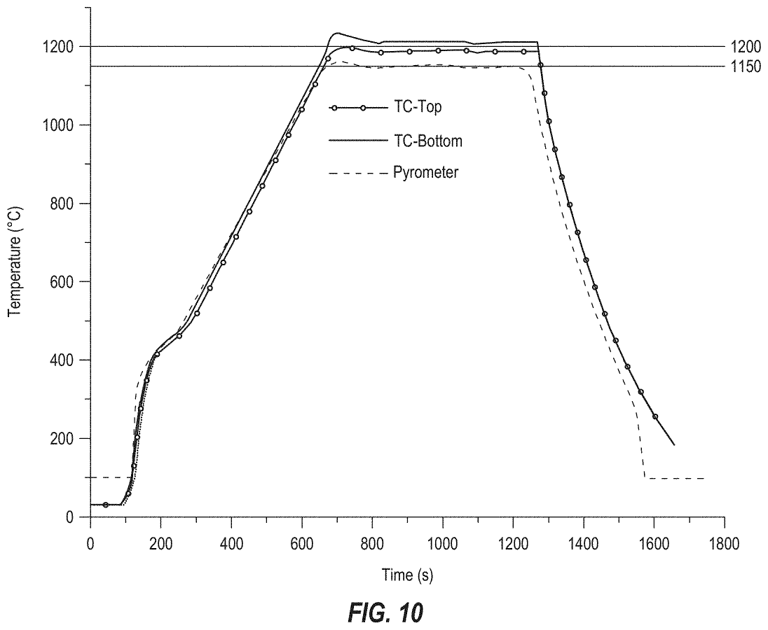

The electric current is directly dependent on the desired fabrication temperature, in addition to the material properties listed above, such as the geometry of the punch, the barrier, and the chemical composition of the materials being joined. In some embodiments, the fabrication temperature may be from about 1050° C. to about 1200° C., such as from about 1100° C. to about 1200° C., from about 1100° C. to about 1190° C., or from about 1100° C. to about 1180° C. In further embodiments, the article is fabricated at a temperature of about 1150° C. It is noted that a temperature of the first material 202 and the second material 206 may differ from (e.g., may be less than, may be greater than) the fabrication temperature during the material joining process. By way of non-limiting example, the fabrication temperature may be about 1150° C., while the temperature of the first material 202 and the second material 206 may be about 1200° C., as shown in FIG. 10.

While FIG. 1 illustrates the application of the electric current 106 before the application of pressure 108, the electric current may be applied substantially simultaneously with or after the application of pressure. After, or at the same time as the 106 step of applying current, the process 100 shown in FIG. 1 applies 108 pressure (e.g., compressive force) to the first material 202, and the second material 206 under constraint of the die 204. The apparatus 200 shown in FIG. 2 includes a mechanism for applying pressure, such as, for example, a pneumatic system 218. The pneumatic system 218 of apparatus 200 may include the upper punch 210 and the lower punch 212. The pneumatic system 218 of apparatus 200 may apply pressure to the first material 202 and the second material 206. The pressure applied to the first material 202 is in an opposite direction of the pressure applied to the second material 206. The pressure applied 108 to the first material 202 and the second material 206 by the upper punch 210 and the lower punch 212, respectively, may be from about 20 mega pascals (MPa) to about 50 MPa, such as about 20 MPa. The acts of applying 106 electric current to generate heat and applying 108 pressure to the die 204, the first material 202, and the second material 206 include holding a substantially constant electric current and pressure for a pre-determined amount of time (e.g., hold time). The hold time may range from about 10 minutes (min) to about 90 min, such as from about 20 min to about 60 min, and such as from about 28 min to about 38 min. In some embodiments, the hold time is about 30 min.

Additional processing parameters, such as bonding atmosphere (e.g., such as a vacuum, an argon atmosphere, a helium atmosphere), heating rate, and surface finish may be selected to achieve the desired material properties of the article 215. For example, the heating rate may be in a range of about 1° C. per minute (° C./min) to about 300° C. ° C./min, such as from about 10° C. to about 250° C., from about 50° C. to about 200° C., or from about 75° C. to about 175° C. The heating may be monitored by a pyrometer 226 external to the die 204. The surfaces of each of the first material 202 and the second material 206 may be processed to exhibit substantially smooth and planar surfaces. The process of preparing 101 the surface of the materials may include polishing (e.g., abrasive polishing) the surface of the materials. By way of example only, silicon carbide (SiC) abrasive papers, such as SiC abrasive papers ranging from about 240 grit to about 1200 grit, may be used. Alternatively, the preparation 101 of the surfaces may include wire brushing, sand blasting, emery cloth polishing, or using degreasers, nitric acid, sodium hydroxide, or hydrofluoric acid to clean and decontaminate the first material 202 and the second material 206. The preparation 101 may further include cleaning the surface to be bonded with a solvent, such as with ethanol, distilled water, or acetone. A lap may be used to smooth the surfaces of the first material 202 and the second material 206. The preparation 101 may further include using an ultrasonic agitator bath to prepare the substantially smooth and planar surfaces. The duration of conducting the ultrasonic agitator bath may be from about 5 minutes to about 10 minutes.

The application of electric current and pressure to the apparatus 200 containing the first material 202 and the second material 206, for a desired hold time, forms the article 215. The application of both electric current and pressure may be controlled by the system controller 220. In preparation for the application of the electric current, and after the first 202 and second 206 materials are placed in the die 204, the apparatus 200 may be evacuated and back filled with argon, helium, or another inert gas. The evacuated pressure may be in the rage of from about 1×10⁻² to about 3×10⁻² Torr. The current and pressure are applied to the die 204. After applying the electric current 106 and applying the pressure 108, the article 215 is removed 110 from the die 204 of the apparatus 200. The article 215 may be cooled by the cooling system 228 before removal or may be allowed to cool slowly. An optional post-forming treatment (e.g., a heat treatment followed by a quenching or air cooling) 112 may be conducted on the article 215 to form a treated article. The post-forming treatment 112 may include heating and cooling of the article 215 to achieve the desired properties of the treated article. The article 215 may be heated (e.g., solution-annealed) to a temperature of from about 1050° C. to about 1200° C., such as from about 1100° C. to about 1200° C. In some embodiments, the article 215 is heated to a temperature of about 1150° C. The post-forming treatment 112 may be conducted for a duration of from about 6 hours to about 12 hours at the chosen temperature. After the post-forming treatment 112, the article is cooled, such as furnace cooled or quenched (e.g., water quenched or oil quenched).

The article 215 formed by the process 100 described above may exhibit substantially the same or improved material properties, such as creep, elevated-temperature fatigue, and creep-fatigue, as the material properties of the wrought-product form. Additional acts to form a compact heat exchanger for nuclear applications from the article 215 may be performed by conventional techniques. It is believed that the material joining process 100 may overcome the challenges of a conventionally diffusion welded INCONEL® 617, while also significantly decreasing energy usage. By using the material joining process (e.g., SPS, EFAS) of the disclosure, the article 215 may be formed quickly and efficiently due to the Joule heating of the first and second materials 202, 206 and a shorter processing time. The resulting article 215 is also more capable of maintaining the original material properties in the wrought product form. Maintaining or improving the properties of the wrought-product form is desirable because of the often-stringent performance requirements of the compact heat exchangers, such as gas-cooled intermediate heat exchangers for nuclear applications.

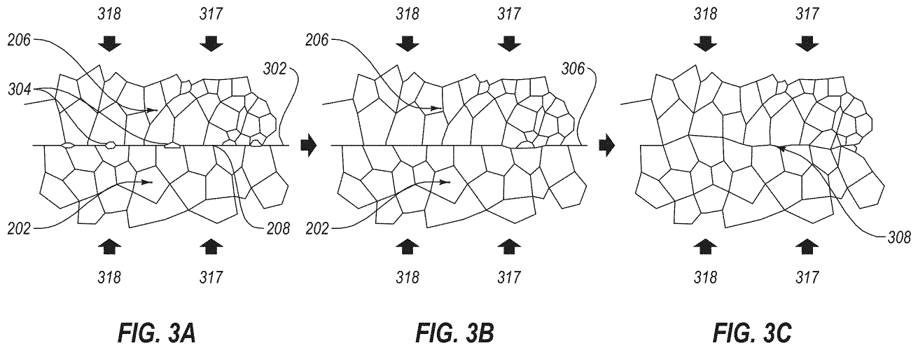

During the material joining process, according to embodiments of the disclosure, a material boundary (e.g., the contact surface 208, an interface) between the first material 202 and the second material 206 may be improved. FIGS. 3A, 3B, and 3C show a progression for the material boundary during the joining process. As used herein, the term “interface” between materials means and includes one or more regions of contact between the materials to be joined. By way of example, two materials may be diffusion welded at multiple interfaces (i.e., contact surfaces). Pores 304 and precipitates 302 may initially be present along the contact surface 208 between the two materials and, if more two layers of material are to be joined, at each subsequent contact surface 208. As pressure 318 and current 317 are applied, as shown in FIG. 3B, the pores 304 and precipitates 302 are eliminated from the contact surface 208, and a pore-free and precipitate-free boundary 306 is present. After maintaining the pressure and current at their respectively chosen values for a sufficient hold time, grain boundary migration may begin. An article having the first material 202 and the second material 206 joined together is shown in FIG. 3C, with substantially no boundary 306 between the first material 202 and the second material 206. The article may have substantially the same material properties as before the joining process took place, assuming that the material compositions of both materials were the same. The boundary 306 is not present in the article because the pore and precipitate boundary 306 has formed a grain migration region 308.

Without being bound by any theory, it is believed that the application of the high current density may increase vacancy defect migration and, thus, improve the diffusion coefficient of the joined materials. The vacancy defect migration may occur at a higher rate when assisted by high current density. The higher amount of vacancy defect migration may lead to a greater amount of grain boundary migration, as shown schematically in FIG. 3C. The high current density has also been found to reduce the yield strength of the materials and contribute to a rapid consolidation. The electric current applied during the joining process 100 may minimize precipitate formation at the interface resulting in increased grain boundary migration. The diffusion weld between the first material 202 and the second material 206 also exhibits less porosity at the interface, limited precipitation growth, evidence of grain growth across the interface (i.e., the interface between two materials, which form the article, is no longer visible), and a more homogeneous structure (e.g., metallurgical continuity) across the width of the article due to even heat distribution by the applied electric current during the joining process 100. Additionally, the application of the high current density may remove surface oxide layers, further improving the quality of the joining process and the metallurgical continuity of the interface between the two or more joined materials. The increased grain boundary migration, as shown in the grain migration region 308 of FIG. 3C, allows the article formed by the joined materials to exhibit the properties desired for its use. Failure to improve the grain boundary migration results in a brittle weld interface that may fail in high temperature applications, as is seen using conventional hot pressing processes of joining materials.

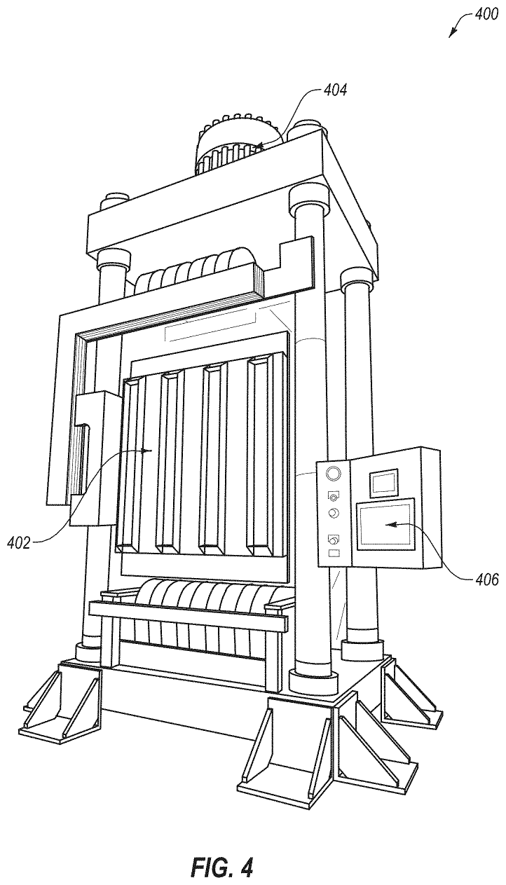

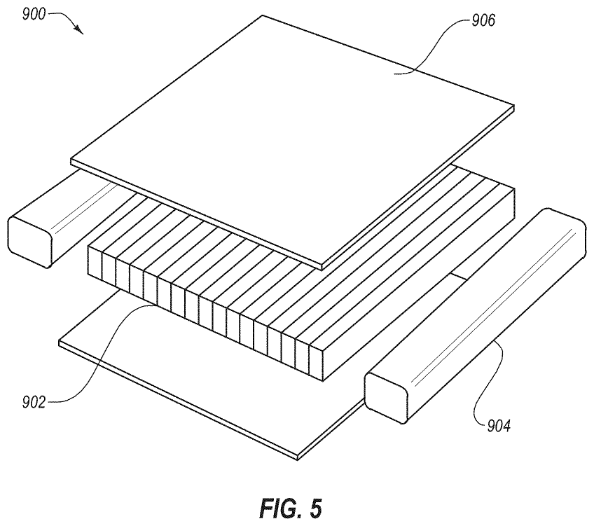

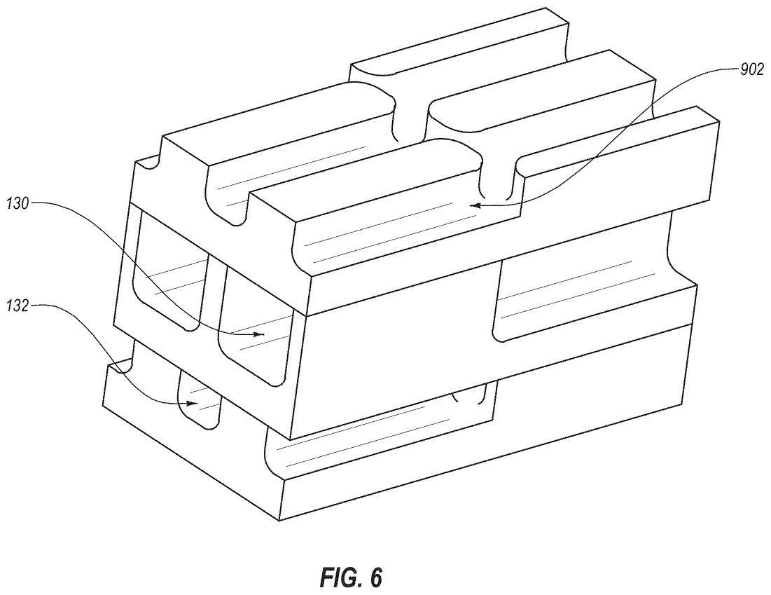

FIG. 4 shows a schematic of a tool 400 which may be used to manufacture the article, in accordance with embodiments of the disclosure. The tool 400 of FIG. 4 is a direct current sintering (DCS) furnace (e.g, SPS furnace) that may be used to join materials up to about one square meter in size, such as the model DCS-800, which is located at the Energy Systems Laboratory at the Idaho National Laboratory. The DCS-800 is configured to operate at high power, high temperatures, and high pressure, and is one of the largest machines of its kind in the world. The tool 400 may comprise a furnace 402, a pressure apparatus 404, and a user interface 406, among the other components of the apparatus 200 shown in FIG. 2, which are not shown in FIG. 4 for simplicity. The DCS-800 may be utilized to form the articles according to embodiments of the disclosure. For instance, fabricating the article at desired large size dimensions may be achieved with the DCS-800. For example, a compact heat exchanger may be fabricated by joining (e.g., welding) multiple articles (e.g., diffusion welded plates) together. Depending on the size of the article to be formed, other DCS furnaces may be utilized in accordance with embodiments of the disclosure, such as the DCS-5 from Thermal Technology, LLC, which is configured to apply a direct current and is capable of operating at a maximum temperature of 2500° C., an applied force (e.g., pressure, compressive force) of 50 kN, and a peak current of 2000 A. Section IX of the ASME Boiler and Pressure Vessel Code specifies size requirements to qualify the joining process (e.g., diffusion welding, SPS).

FIG. 5 is a schematic of an article configured as a plate-fin compact heat exchanger 900. The compact heat exchanger 900 includes heat transfer fins 902, which enable hot air and cool air to pass through. Parting sheets 906 function as a top layer and a bottom layer of the plate-fin compact heat exchanger 900, with side regions 904 adjacent to the heat transfer fins 902. The article may be configured, however, as another type of compact heat exchanger. As non-limiting examples, the compact heat exchanger may include a unit cell heat exchanger or a printed circuit heat exchanger. FIG. 6 is an enlarged view of the compact heat exchanger heat transfer fins 902, which exchange hot and cool air through its channels. Hot air may be exchanged alternately through channel 132 and cold air through channel 130.

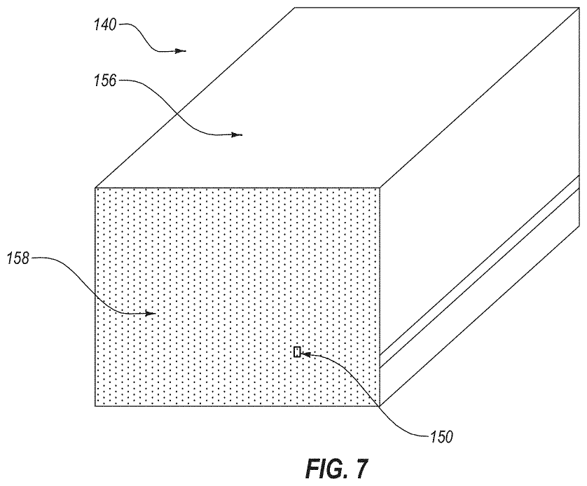

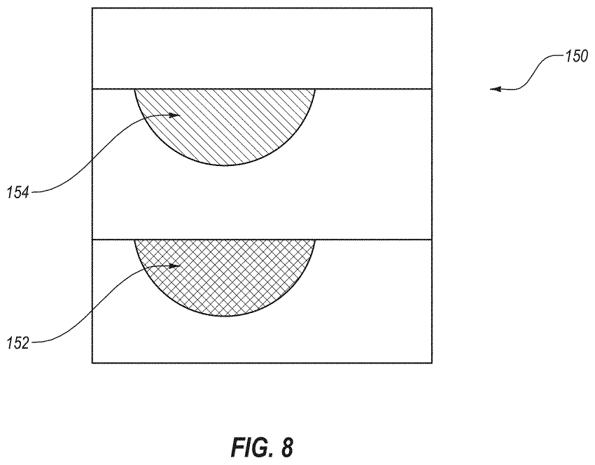

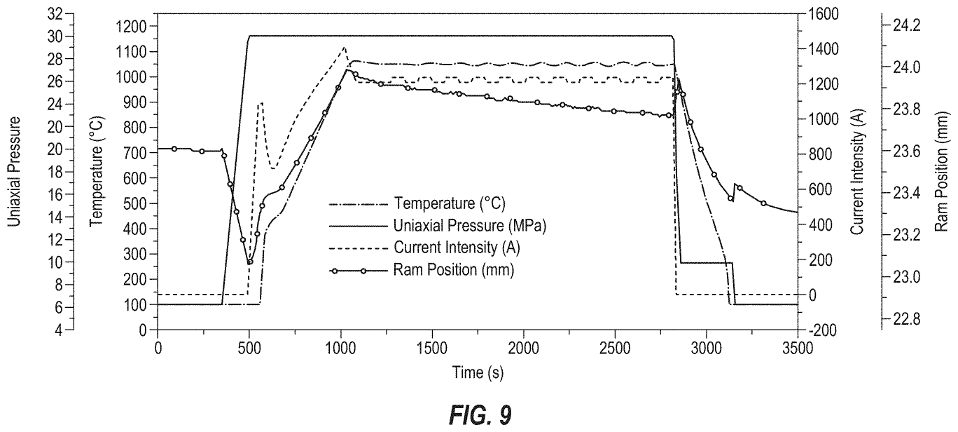

FIGS. 7 and 8 show a compact heat exchanger 140 exhibiting another example configuration of heat transfer channels 154 and 152. As seen in FIG. 7, many heat transfer channels 154, 152 may be present on a surface 158 of the compact heat exchanger 140. The compact heat exchanger 140 may be enclosed by an outer layer 156 to protect the heat transfer channels 154, 152. FIG. 8 shows an enlarged view of the heat transfer channels 154, 152 in the region indicated by 150. For simplicity, only a single heat transfer channel 154 (e.g., a hot heat transfer channel) and a single heat transfer channel 152 (e.g., a cold heat transfer channel) are shown in FIG. 8. The heat transfer channels 154, 152 of the compact heat exchanger 140 may function similarly to the heat transfer fins 902 of the plate-fin compact heat exchanger 900. The geometry, however, of the heat transfer fins 902 and heat transfer channels 150 is different, with the heat transfer fins 902 having a rectangular prism-like shape and the heat transfer channels 154, 152 having a half-cylindrical-like shape. The heat transfer fins 902 or heat transfer channels 150 are not, however, limited to the shapes illustrated in FIG. 6 or 8. The geometry of the heat transfer fins 902 and heat transfer channels 150 may be configured as other shapes including but not limited to a cylindrical shape, an extruded diamond prism shape, extruded oval prism shape, or some other non-normal prism shape.

The following examples serve to explain embodiments of the present invention in more detail. These examples are not to be construed as being exhaustive or exclusive as to the scope of this invention.

### EXAMPLES

Diffusion Welding (DW) of Alloy 617 using an EFAS process was conducted using a Direct Current Sintering Furnace DCS-5 from Thermal Technology, LLC. (USA). The chemical composition of the Alloy 617 sheets is shown below in Table 1. The Alloy 617 sheets in solution-annealed condition were utilized as the starting material in this study. The Alloy 617 sheets (heat XX6083UK) with a thickness of 1.6 mm were procured from High Temp Metals, Inc. (USA). The sheets were sectioned to 14.14 mm×14.14 mm (diagonal length of 20 mm) coupons. Both surfaces of the square coupons were mechanically ground using SiC abrasive papers up to 1200 grit to achieve flat and parallel surfaces as well as to remove surface oxides, defects, and contaminations. The prepared sheets were raised with distilled water, cleaned with acetone in an ultrasonic bath for 10 minutes, raised with ethanol, and finally air-dried. The surface roughness of three random sheets was measured using a Veeco profilometer. Measurements showed a peak Ra of 0.029 μm and Rz of 0.97 μm. Three coupons were stacked together and loaded into 20-mm inner diameter graphite die. The square sample was smaller than the die cavity and therefore, allowed unconstrained compression during the DW (material flow in the direction perpendicular to the applied force due to creep and/or yielding at the bonding temperature). Graphite foils with a thickness of 0.127 mm were placed in the contact surfaces of the die assembly for easy removal of the sample after the experiment.

TABLE 1
Chemical composition of the Alloy 617 sheets

| Element | Ni | Cr | Co | Mo | Al | C | Fe | Mn | Si | S | Ti | Cu | B | P |
|---|---|---|---|---|---|---|---|---|---|---|---|---|---|---|
| Alloy 617 | 52.5 | 21.8 | 12.9 | 9.6 | 1.13 | 0.09 | 1.17 | 0.08 | 0.07 | 0.001 | 0.38 | 0.04 | 0.004 | 0.006 |

The EFAS process was conducted at the temperatures of 1050° C., 1100° C. and 1150° C., at a pressure of 10 MPa, 20 MPa and 30 MPa, and hold time of 10 minutes, 30 minutes, and 90 minutes. The total electric current flowing through the die assembly was 1240 A, 1322 A, and 1377 A for the temperature of 1050° C., 1100° C., and 1150° C., respectively. The current passing through the sample, however, depended on several factors including the material properties, punch and die geometries, and sample size. The process parameters are shown in Table 2.

The EFAS process was compared to a conventional hot pressing process, which parameters are also in Table 2. The comparative experiments were conducted using an Oxy-Gon hot press furnace in an argon environment. During hot pressing, the sample in the graphite die was subjected to uniaxial pressure and elevated temperature at the same time. The sample was heated by conventional resistive heating elements in the hot pressing furnace while compressed by upper and lower hydraulic rams. No electric current passed through the sample during hot pressing (HP). The hot pressing was performed under pressure of 20 MPa and 30 MPa, hold time of 30 min and 90 min, and temperatures of 1150° C. and 1200° C., as listed in Table 2. Due to a temperature gradient in the die assembly during the EFAS process (explained below), the hot pressing experiments were conducted at 1200° C. with a zero-current analog of EFAS performed at 1150° C. (e.g., EFAS-#7 vs. HP-#2, EFAS-#8 vs. HP-#4). The heating rate during hot pressing was set at 100° C./min. Subsequent cooling of the samples was conducted in the hot press chamber with an uncontrolled cooling rate of ˜50° C./min.

TABLE 2
Design matrix for DW of Alloy 617 by EFAS and HP.

| | Temperature | Pressure | Hold time | |
|---|---|---|---|---|
| Process | (° C.) | (MPa) | (min) | Sample ID |
| HP | 1150 | 20 | 90 | HP-#1 |
| | 1200 | 20 | 90 | HP-#2 |
| | 1150 | 30 | 30 | HP-#3 |
| | 1200 | 30 | 30 | HP-#4 |
| EFAS | 1050 | 30 | 30 | EFAS #1 |
| | 1100 | 30 | 10 | EFAS-#2 |
| | 1100 | 30 | 30 | EFAS-#3 |
| | 1150 | 10 | 30 | EFAS-#4 |
| | 1150 | 20 | 10 | EFAS-#5 |
| | 1150 | 20 | 30 | EFAS-#6 |
| | 1150 | 20 | 90 | EFAS-#7 |
| | 1150 | 30 | 30 | EFAS-#8 |

During the EFAS process, the electric current initiated from the upper electrode passed through the die as well as a stack of three sheets of Alloy 617, due to the good electrical conductivity of Alloy 617. The primary heating mechanism of the three sheets was Joule heating. FIG. 5 shows the evolution of processing parameters including temperature, applied pressure, current intensity, and hydraulic ram position during the EFAS process. The DCS-5 chamber was evacuated to 2×10⁻² Torr and was backfilled with argon or helium gas. Subsequently, uniaxial pressure was applied and gradually increased to the target pressure. An electric current was then applied to heat the die assembly to 300° C. and held for 1 minute so that the pyrometer could capture the temperature. After the hold, the electric current was increased and the die assembly was heated to the target temperature at a rate of 100° C./min. The pressure and temperature were kept constant during the dwelling stage. After dwell, the current and pressure were released. Consequently, the sample cooled down to room temperature at −200° C./min.

As shown in FIG. 5, the user controlled parameters were kept substantially the same for the duration of the hold time. A ramp rate for current intensity in FIG. 5 was about 1.4 A per second or 84A per minute. The ram position in FIG. 5 shows how the material deformed in response to the temperature, pressure, and current. FIG. 5 shows that the joining process is an efficient one as the process lasted approximately one hour.

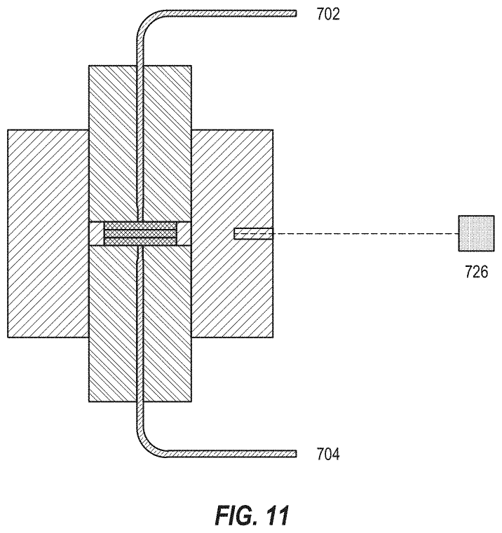

During the EFAS method, the temperature was monitored using a pyrometer 726 aimed at a hole on the graphite die. Sample temperature was measured by two type C thermocouples 704 and 702 running through the upper and lower punches. FIG. 11 shows a simplified view of this temperature measuring system. Due to the Joule heating mechanism, a temperature gradient can exist in the die assembly. As a result, the sample temperature could be different from the temperature measured by the pyrometer 726. The sample temperature and pyrometer reading during the EFAS process at 1150° C. are plotted in FIG. 10, which confirmed a temperature gradient within the die assembly. The temperature on the sample surface was close to 1200° C., which is about 50° C. higher than the pyrometer reading (1150° C.).

To characterize the samples produced through the EFAS method, they were sectioned to reveal the diffusion-weld interfaces. The sectioned samples were mounted in Bakelite and mechanically ground and polished following conventional metallography procedures. Vibratory polishing was carried out in 0.02 μm colloidal silica suspension for about 4 hours. The weld interfaces were inspected using a light optical microscope (Keyence VHX6000) and a scanning electron microscope (FEI Quanta FEG 650) equipped with energy-dispersive X-ray spectroscopy and electron-backscattered diffraction. Electron-backscattered diffraction maps (EBSD) were captured with a step size of 2 μm. The EBSD data was post-processed in orientation imagery microscopy (OIM) analysis software. Data with less than a 0.1 confidence index was removed from the data set. The grain size of the samples was measured. Grains were defined as a minimum of 5 pixels. A grain boundary (GB) was defined as a disorientation angle of 5° between neighboring pixels. Grain boundary migration across the interface was quantified as the percent of the interface with grain boundary migration compared to the total length of the interface. Optical micrographs were taken over the entire length of both interfaces and the summation of both interfaces was used to quantify the grain boundary migration. Grain boundaries were revealed with a 10% oxalic electrochemical etch at 2.2 V for 30 seconds. To characterize the fine precipitates of the diffusion-welded Alloy 617, characterization using transmission electron microscopy (TEM) was performed. Lift-out samples for TEM analysis were prepared using the FEI Contra 3D FEG dual-beam focused ion beam (FIB) microscope. TEM imaging and Electron Dispersion Spectroscopy analysis were performed using a FEI Tecnai TF30-FEG STwin TEM.

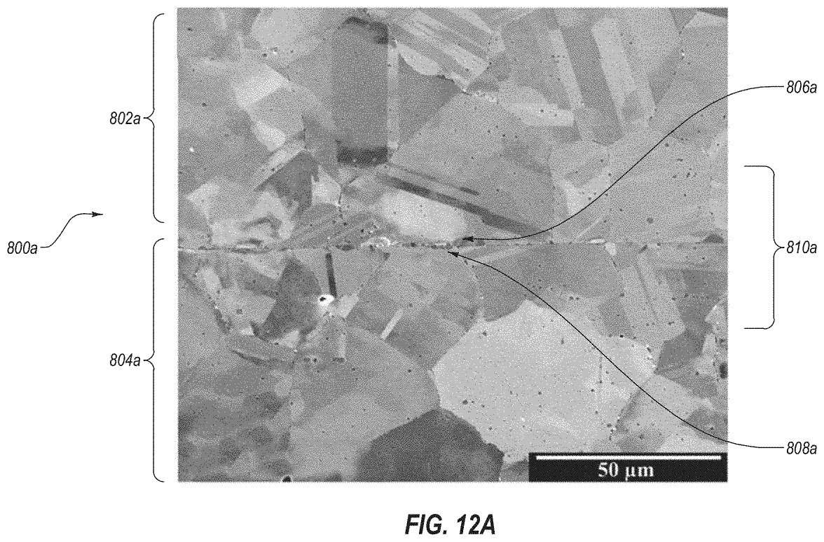

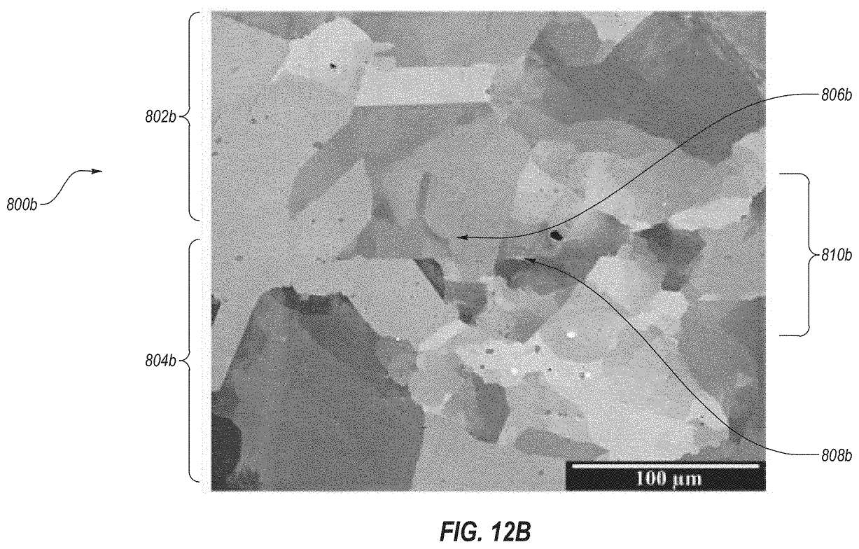

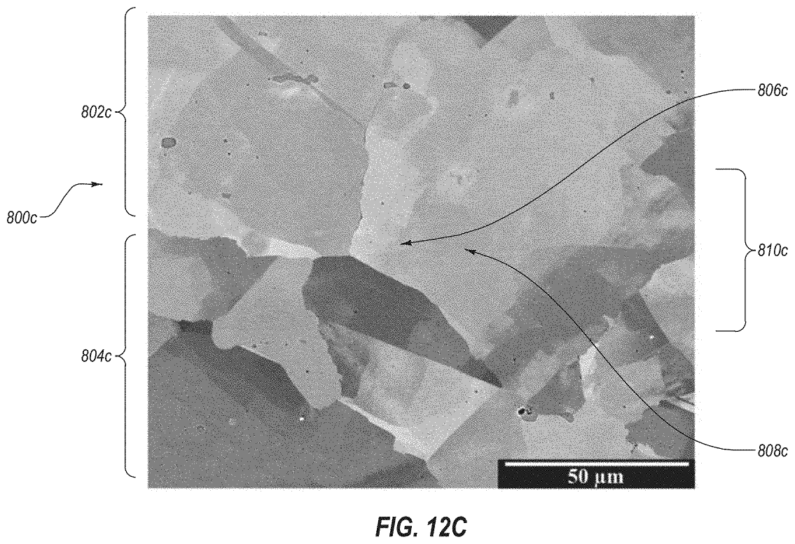

FIG. 12A through FIG. 12C are back scattered electron photomicrographs, taken with the SEM, of 3 samples (EFAS #1, EFAS #7, and EFAS #8) from Table 2. 800A, 800B, and 800C correspond to EFAS #1, EFAS #7, and EFAS #8 respectively and were produced with the EFAS method as described above. The three samples 800A, 800B, and 800C included the Alloy 617 material 802a, 802b, 802c and the Alloy 617 material 804a, 804b, 804c described above in Table 1 and the samples were prepared using the process parameters listed in Table 2. A first contact surface 806a, 806b, 806c of the first material 802a, 802b, and 802c was in direct contact with a second contact surface 808a, 808b, 808c of the second material 804a, 804b, 804c in the die of the DCS-5 and were heated using joule heating.

As shown in FIG. 12A, the article 800a exhibited a heterogeneous crystallographic structure in a contacting region (e.g., bonding interface) 810a where the contact surface 806a of the first material 802a was adjacent to (e.g., in direct contact with) the contact surface 808a of the second material 804a. Article 800a was heated, using joule heating, to 1050° C. with 30 MPa of pressure applied for a hold time of 30 min. Precipitates were present at the interface and throughout the article 800a. The presence of such precipitates at the interface, along with the pores on the interface affected the properties of this article 800a. As shown in FIG. 12A, it was not sufficient to apply the electric current, high pressure, and hold time in order to join the first 802a and second 804a materials effectively as the interface contained precipitates and did not display grain boundary migration.

In contrast to article 800a, the article 800b exhibited a substantially homogeneous crystallographic structure in a contacting region (e.g., bonding interface) 810b where the contact surface 806b of the first material 802b was adjacent to (e.g., in direct contact with) the contact surface 808b of the second material 804b. The article 800b was joined at a temperature of 1150° C., heated with Joule heating, and an applied pressure of 20 MPa with a hold time of 90 min. The contacting region 810b of the article 800b was substantially free (e.g., lacks) of voids and was substantially free (e.g., lacks) from cracks. The contacting region 810b was also substantially free from pores (e.g., lacks porosity). The article 800b exhibited a variety of different precipitates at the contacting region 810b but these precipitates were slowed so that grain boundary migration was increased. The composition of these precipitates varied depending on the process parameters used and the location across a width of the specimen. The formation of precipitates, however, depended on the fabrication temperature generated by the electric field. Therefore, the application of electric current and temperature retarded precipitation and achieved significant grain boundary migration across the interface.

A further example in FIG. 12C exhibited similar characteristics to that of FIG. 12B. The article 800c exhibited a substantially homogeneous crystallographic structure in the contacting region 810c. Additionally, the contacting region 810c of the article 800c was substantially free from voids and was substantially free from cracks. The contacting region 810c was also substantially free from pores. The article 800c was joined at a temperature of 1150° C., generated by an electric current of 1377 A and a pressure of 30 MPa, with a hold time of 30 min. Given the similar crystallographic structures observed between articles 800b and 800c, the changes in pressure and hold time did not substantially change the amount of precipitates at the interface and, thus, did not substantially change the amount of grain boundary migration that takes place across the interface. However, the amount of precipitates at the interface and, thus, the amount of grain boundary migration changed, which is believed to be due to the amount of current, combined with the applied pressure and the resulting temperature.

A summary of the properties of the samples prepared by EFAS and HP are shown below in Table 3.

TABLE 3
Summary of Diffusion-Welded Alloy 617 Fabricated Using HP and EFAS.

| | | | | Intergranular | | % GB |
|---|---|---|---|---|---|---|
| | DW | | Porosity | and | Precipitates | migration |
| | temperature | | at DW | intragranular | at DW | across DW |
| Process | (° C.) | Deformation | interface | precipitates | interface | interface* |
| HP | 1150 | 19.1% | Yes | Yes | Yes | 3.6% |
| | 1200 | 34.4% | No | Significantly | Yes | 53.2% |
| | | | | reduced | | |
| EFAS | 1050 | 2.8% | No | Yes | Yes | 0 |
| | 1100 | 7.1% | No | Yes | Yes | Insignificant |
| | 1150 | 23.1% | No | Significantly | No | 88.5% |
| | | | | reduced | | |

*Excluding the edges with Al-rich oxides

As seen in Table 3, precipitates were observed at the interface of the two materials in the hot pressing experiments. Because of these precipitates, very limited grain boundary migration was achieved by hot pressing. These precipitates were caused by passivation oxides of Alloy 617. Although the passivation oxides protect Alloy 617 from oxidation and corrosion, these stable surface oxides largely restrict diffusion across the interface during diffusion welding. In contrast to hot pressing, precipitates were not observed in the EFAS sample fabricated at 1150° C. Considering that both the EFAS and hot pressing experiments were conducted at a temperature equivalent to 1150° C., the difference in precipitation between the EFAS and hot pressing samples is most likely a consequence of the applied electric current. Not only is the EFAS environment highly reductive, it has been shown that one of the thermal effects of EFAS is surface cleaning of metals and dielectric breakdown of metal oxides.

For Alloy 617, the above results show the application of electric current impeded precipitation. Since precipitates were not formed along the diffusion-weld interface for the sample fabricated at 1150° C., significant grain boundary migration across the diffusion-weld interface was achieved by the EFAS process. The high current density also enhanced vacancy defect migration and thus improved atom diffusion, which may increase the mechanical strength of the diffusion-welded interfaces. Samples heated at the same temperatures (1150° C.) by the hot pressing process and by the EFAS process did not result in the same diffusion-welded interface. Extensive precipitates were distributed along the interface of the hot-pressed samples, which limited grain boundary migration across the interface. In contrast, the samples exposed to the EFAS process under different temperatures demonstrated the importance of welding at the correct temperature.

Therefore, the impact of an applied electric current during the diffusion welding of Alloy 617 was determined. For the Alloy 617 sheets diffusion-welded using the EFAS process, the applied current had a significant influence on precipitation and grain boundary migration. Coupled with diffusion welding at the correct temperature, the EFAS process achieved superior interface quality over hot pressing based on the following observations: 1) at 1150° C. interfacial precipitates were eliminated by the EFAS process and 2) substantial grain boundary migration (88.5%) was achieved by the EFAS process across the interface compared with 3.6% for the HP process at 1150° C.

While embodiments of the disclosure may be susceptible to various modifications and alternative forms, specific embodiments have been shown by way of example in the drawings and have been described in detail herein. However, it should be understood that the disclosure is not limited to the particular forms disclosed. Rather, the disclosure encompasses all modifications, variations, combinations, and alternatives falling within the scope of the disclosure as defined by the following appended claims and their legal equivalents.

What is claimed is:

1. A method of forming an article, comprising:
placing a first material and a second material in a die of a direct current sintering apparatus, the second material directly contacting the first material; and
applying an electric current and pressure to the first material and the second material to form an article.

2. The method of claim 1, wherein placing a first material and a second material in a die comprises placing a sheet of the first material and a sheet of the second material in the die.

3. The method of claim 1, wherein placing a first material and a second material in a die comprises placing a first electrically conductive material and a second electrically conductive material in the die.

4. The method of claim 1, wherein placing a first material and a second material in a die comprises placing a first sheet of a nickel-based alloy in direct contact with a second sheet of a nickel-based alloy, a material composition of the first sheet and the second sheet being the same.

5. The method of claim 1, wherein placing a first material and a second material in a die comprises placing a first sheet of a nickel-based alloy in direct contact with a second sheet of a nickel-based alloy, a material composition of the first sheet and the second sheet being different.

6. The method of claim 1, wherein applying an electric current and pressure to the first material and the second material comprises applying the electric current across the first material and the second material at from about 1,240 amps to about 50,000 amps.

7. The method of claim 1, wherein applying an electric current and pressure to the first material and the second material comprises applying the electric current across the first material and the second material at from about 10,000 amps to about 50,000 amps.

8. The method of claim 1, wherein applying an electric current and pressure to the first material and the second material comprises applying the electric current across the first material and the second material at from about 35,000 amps to about 50,000 amps.

9. The method of claim 1, wherein applying an electric current and pressure to the first material and the second material comprises applying the pressure to the first material and the second material at from about 20 megapascals (MPa) to about 50 MPa.

10. The method of claim 1, wherein applying an electric current and pressure to the first material and the second material comprises substantially simultaneously applying the electric current and pressure to the first material and the second material.

11. The method of claim 1, wherein applying an electric current and pressure to the first material and the second material comprises applying the electric current to the first material and the second material before applying the pressure to the first material and the second material.

12. A method of forming an article, comprising:
placing a nickel-based material in direct contact with one or more other nickel-based materials to form a stack of nickel-based materials; and
applying electric current and pressure to the stack of nickel-based materials to join the nickel-based material and the one or more other nickel-based materials.

13. The method of claim 12, wherein placing a nickel-based material in direct contact with one or more other nickel-based materials to form a stack of nickel-based materials comprises forming the stack of nickel-based materials comprising nickel, chromium, cobalt, molybdenum, aluminum, carbon, iron, manganese, silicon, sulfur, titanium, copper, boron, and phosphorus.

14. The method of claim 12, wherein applying electric current and pressure to the stack of nickel-based materials comprises heating the stack of nickel-based materials to a temperature of from about 1050° C. to about 1200° C.

15. The method of claim 12, wherein applying electric current and pressure to the stack of nickel-based materials comprises heating the stack of nickel-based materials by Joule heating.

16. The method of claim 12, wherein applying electric current and pressure to the stack of nickel-based materials to join the nickel-based material and the one or more other nickel-based materials comprises joining from 2 sheets of the nickel-based materials to 100 sheets of the nickel-based materials.

17. An article, comprising:
a first material comprising a first nickel alloy; and
a second material comprising a second nickel alloy, the second material diffusion bonded to the first material and an interface between the first material and the second material substantially free of voids and cracks.

18. The article of claim 17, wherein the first material comprises an alloy of nickel, chromium, cobalt, molybdenum, iron, aluminum, and titanium and the second material comprises an alloy of nickel, chromium, cobalt, molybdenum, iron, aluminum, and titanium.

19. The article of claim 18, wherein the first material comprises a different material composition of nickel, chromium, cobalt, molybdenum, iron, aluminum, and titanium than a material composition of the second material.

20. The article of claim 17, wherein the article is configured as a compact heat exchanger.
